(19) United States
(12) Patent Application Publication
(10) Pub. No.: US 2008/0231626 A1
(43) Pub. Date: Sep. 25, 2008

(54) Method and Apparatus to Facilitate a Differently Configured Virtual Reality Experience for Some Participants in a Communication Session

(75) Inventors: Magdi A. Mohamed, Schaumburg, IL (US); Eric R. Buhrke, Clarendon Hills, IL (US); Julius S. Gyorfi, Vernon Hills, IL (US)

Correspondence Address: MOTOROLA/FETF, 120 S. LASALLE STREET, SUITE 1600, CHICAGO, IL, 60603-3406, US

(73) Assignee: Motorola, Inc., Schaumburg, IL (US)

(21) Appl. No.: 11/689,967

(22) Filed: Mar. 22, 2007

(51) Int. Cl. G06F 17/00

(52) U.S. Cl. 345/418

(57) ABSTRACT

Virtual reality experiences are provided (101 and 102) for a first participant and a second participant. A virtual representation of the second participant's interaction with the shared experience is rendered (103) for the first participant. Similarly, a virtual representation of the second participant's interaction with the shared experience is rendered (104) for the second participant. Upon detecting (105) an interaction between the second participant and a shared virtual component, the virtual representation for the first participant of the second participant's interaction with the shared experience is rendered (106) as though the interaction between the second participant and the shared virtual component had not occurred notwithstanding that the rendering as provided to the second participant does reflect and incorporate that interaction.

### TECHNICAL FIELD

This invention relates generally to virtual reality experiences and more particularly to multi-participant virtual reality experiences.

### BACKGROUND

Interactive virtual reality experiences are known in the art. Such experiences often make use of a multi-media presentation to present a virtual space, such as a room or the like, within which the user can interact with animate and/or inanimate objects and/or other participants. Such experiences are often employed to facilitate an entertainment activity or to facilitate conferencing, event management, or the like. In some cases, the virtual reality experience is shared by more than one participant and one or more of the animate/inanimate objects comprises a shared virtual component in that more than one of the participants can see and/or otherwise interact with that component.

In many cases each participant of a shared virtual reality experience receives a rendering of that experience specific to that participant's substantially unique point of perception. This can comprise, for example, providing the participant with a visual view of the shared virtual reality experience from a particular location within that experience. By this approach, each participant receives a somewhat different rendering of what otherwise constitutes an identical setting and experience.

To illustrate, consider an example where a first participant picks up (using virtual appendages or other provided tools) a given shared virtual component to facilitate visual inspection of that component. That first participant will typically receive a rendering of the virtual reality experience that depicts such manipulation of that component. Similarly, a second participant who shares this virtual reality experience will also receive a rendering of that experience that also depicts such manipulation of that component by the first participant (albeit from a different point of perception as noted above).

For some application settings and purposes, such an approach can be useful and appropriate. There are other application settings and purposes, however, where such an approach can be counterproductive, unnecessarily distracting, and/or otherwise unhelpful. Consider, for example, an application setting where the shared experience comprises a substantially real time, live public safety management experience. In such an example the various participants might comprise, for example, representatives from various public safety agencies such as police, fire fighting, emergency medical services, public utilities, the mayor's office, and so forth.

In such a case, a given shared virtual component, such as a three dimensional rendering of a building that is presently experiencing a real time emergency, may undergo simultaneous examination by various of these participants. This examination can comprise a different exercise for each such participant such that each participant cannot likely glean the information they seek while another of the participants is also manipulating that component. Time can also comprise a critical factor in such an application setting, and it can be unsatisfactory to impose a temporally sequential mode of inspection upon each of the participants.

### BRIEF DESCRIPTION OF THE DRAWINGS

The above needs are at least partially met through provision of the method and apparatus to facilitate a virtual reality experience for multiple participants described in the following detailed description, particularly when studied in conjunction with the drawings, wherein:

FIG. 1 comprises a flow diagram as configured in accordance with various embodiments of the invention;

FIG. 2 comprises a schematic exemplary rendering as configured in accordance with various embodiments of the invention;

FIG. 3 comprises a schematic exemplary rendering as configured in accordance with various embodiments of the invention;

FIG. 4 comprises a schematic exemplary rendering as configured in accordance with various embodiments of the invention;

FIG. 5 comprises a schematic exemplary rendering as configured in accordance with various embodiments of the invention;

FIG. 6 comprises a block diagram as configured in accordance with various embodiments of the invention;

FIG. 7 comprises an exemplary diagram illustrating a first participant's differently configured perspective in two dimensional space;

FIG. 8 comprises an exemplary diagram illustrating a second participant's differently configured perspective in two dimensional space; and

FIG. 9 comprises an exemplary diagram illustrating a third participant's differently configured perspective in two dimensional space.

Skilled artisans will appreciate that elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

Generally speaking, pursuant to these various embodiments, one substantially continuously provides a first virtual reality experience for a first participant and a second virtual reality experience for a second participant. These first and second virtual reality experiences comprise a shared experience that comprises, at least in part, a shared virtual component. These teachings then provide for substantially continuously rendering, for the first participant, a virtual representation of the second participant's interaction with the shared experience (which can comprise, for example, rendering a virtual presentation of the shared virtual component from a point of perception as corresponds to the first participant). Similarly, a substantially continuous rendering, for the second participant, of the virtual representation of the second participant's interaction with the shared experience can comprise rendering a virtual presentation of the shared virtual component from a point of perception as corresponds to that second participant.

These teachings then provide for, upon detecting an interaction between the second participant and the shared virtual component, now substantially continuously rendering for the first participant a virtual representation of the second participant's interaction with the shared experience as though the interaction between the second participant and the shared virtual component had not occurred notwithstanding that the rendering as provided to the second participant does reflect and incorporate that interaction. This can comprise, as one example, rendering (for the first participant) the shared virtual component as though the second participant had not interacted with the shared virtual component and the second participant also as though the interaction had not occurred.

These teachings will further accommodate then rendering, for the first participant, subsequent interactions (such as gazing at or otherwise inspecting the shared virtual component) between the second participant and the component as though the above-described interaction had not occurred. By this approach, for example, the first participant can see and understand that the second participant is looking at the shared virtual component, but will not have seen that the second participant has previously moved that shared virtual component in order to facilitate that inspection and study.

So configured, each participant remains free to share, as they see fit, such virtual components without interfering with one another. At the same time, if desired, each participant can be at least somewhat cognizant of the other participant's interactions with such components (for example, by being able to observe which such components these other participants are gazing at). Those skilled in the art will understand and recognize that these teachings are readily adaptable to present virtual reality approaches and will likely apply to subsequently developed approaches as well. It will further be appreciated that these teachings are both flexible in application and readily scaled to accommodate wide variations with respect to the number of participants, the number of shared virtual components, and the number and kinds of interactions that are shown or hidden.

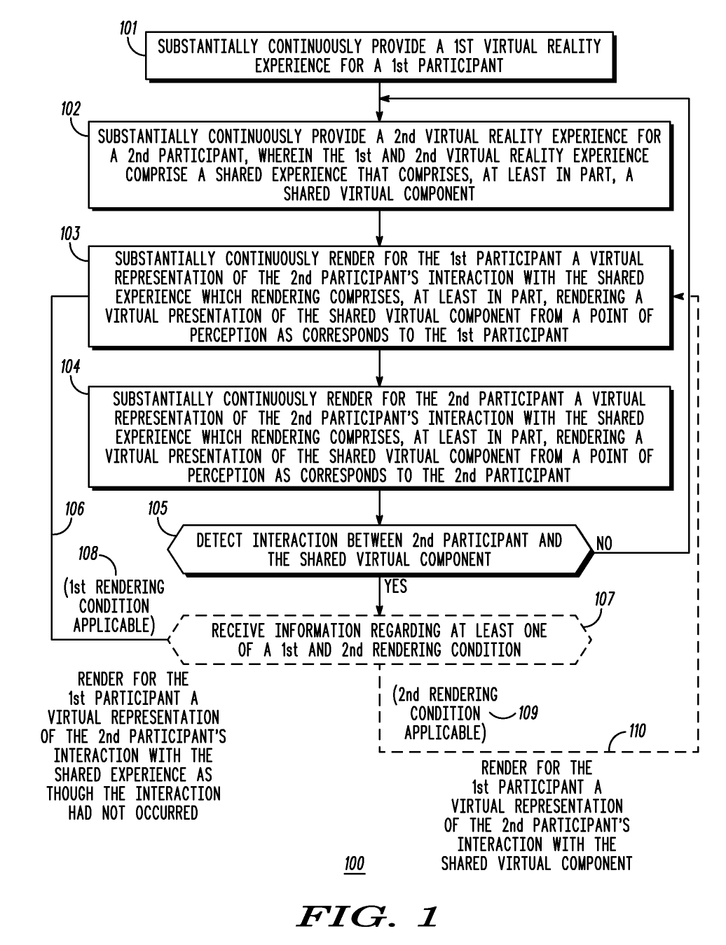

These and other benefits may become clearer upon making a thorough review and study of the following detailed description. Referring now to the drawings, and in particular to FIG. 1, an illustrative process 100 suitable to represent at least certain of these teachings will be described. Pursuant to this process 100 a first virtual reality experience is provided 101 for a first participant on a substantially continuous basis. (Those skilled in the art will understand that, as used herein, “substantially continuous basis” refers generally to a characterization regarding provision of the experience while providing that experience and is not a suggestion that the experience itself, once provided, must never conclude.) This virtual reality experience can comprise any of a wide variety of experiences, including but not limited to interactive experiences, as are presently known or as may be developed going forward.

By one approach this experience can comprise an experience that provides substantially real-time interaction with at least one other user. This can comprise, for example, a collaborative environment where persons having a shared interest can share data, confer, propose ideas, and, in general, manage a corresponding process of interest. So configured, for example, users collaborating in the virtual reality experience may be able to share access to one or more informational inputs.

The virtual setting itself can also comprise any of a wide variety of form factors and/or constructs as desired. By one approach, this virtual setting can comprise a virtual room (such as, but not limited to, a conference room or a command center) having tools and the like to facilitate the sharing of information. Such tools can comprise, but are not limited to, virtual display screens, user manipulable controls, and so forth.

Also, if desired, this interactive virtual reality experience can include the use of avatars that represent (in as realistic or fanciful a manner as desired) the various users who are interacting within the virtual setting with one another. Such avatars can serve to assist with interacting with other elements of the virtual setting and/or to facilitate an understanding of which user is offering which inputs.

In a not untypical scenario, this step of providing a first interactive virtual reality experience may comprise using one or more application servers that assemble and provide (often using streaming technologies of choice) the corresponding renderable content to the users via a client application (or applications). In general, the elements of providing such an experience are well known in the art and require no further elaboration here.

This process 100 then further provides for also substantially continuously providing 102 a second virtual reality experience for a second participant, wherein the first virtual reality experience (as is provided to the first participant) and this second virtual reality experience comprise a shared experience. For example, when the shared experience comprises a virtual reality construct placed within a command center (as may be appropriate when the shared experience comprises a substantially real time, live public safety management experience), these first and second virtual reality experiences can comprise views of this command center that accord to the relevant points of perception of the first and second participants, respectively. For the sake of simplicity and clarity, only two such participants are described herein. Those skilled in the art will understand and appreciate, however, that these teachings are not so limited. Instead, it will be well understood that essentially any number of participants can be similarly included and accommodated by such teachings.

By one approach, this shared experience can itself comprise, at least in part, one or more shared virtual components. These shared virtual components can correspond to a real world counterpart (such as, for the sake of illustration and not by way of limitation, an object such as a building, a vehicle, an urban setting, a tool, a product, an item of industrial equipment, and so forth) or to a fanciful item having no known real world counterpart as desired. The extent to which such a component is sharable can vary with the limitations and/or opportunities as tend to characterize a given application setting as well as the desires and/or requirements of those who are responsible for carrying forth these teachings. Examples of shareability include, but are not limited to, being visually ascertainable by multiple participants, being audibly ascertainable by multiple participants, being haptically sensible by multiple participants, being olfactorilly sensible by multiple participants, being movable, manipulable, and/or reorientable by multiple participants, and so forth.

So provisioned, this process 100 then provides for substantially continuously rendering 103, for the first participant, a virtual representation of the second participant's interaction with the shared experience. This can further comprise rendering a virtual presentation of the shared virtual component from a point of perception as corresponds to the first participant. This point of perception might comprise, for example, a point of view as corresponds to a present position and orientation of the first participant within the shared experience. To illustrate, for example, when the second participant causes their corresponding avatar to move to a new location within the shared experience (to another side, for example, of a shared virtual component), the rendering provided to the first participant can depict such movement of the second participant's avatar about the shared virtual component. (Much the same can of course be provided for the benefit of the second participant; for the sake of simplicity and clarity, however, such details are dispensed with here.)

Somewhat similarly, this process 100 also provides for substantially continuously rendering 104 for the second participant a virtual representation of the second participant's interaction with the shared experience. This, again, can comprise, at least in part, rendering a virtual presentation of the shared virtual component from a point of perception as corresponds to the second participant. To continue with the simple illustration presented above, as the second participant causes their corresponding avatar to move about the shared experience, the rendering of the shared experience provided to the second participant will depict and reflect such movement. Should this comprise, for example, moving their avatar to the right of a given shared virtual component, this rendering can comprise depicting that shared virtual component from a location further to the right of a previous rendering. (Again, much the same can of course be provided for the benefit of the first participant but again, for the sake of simplicity and clarity, such details are dispensed with here.)

This process 100 then provides for detecting 105 an interaction between the second participant and a shared virtual component of interest. The particular nature of the interaction so detected can vary with the needs and/or capabilities of a given instantiation. By one approach, this might include only interactions than involve actual movement or manipulation of the shared virtual component itself. It would also be possible to condition this detection upon one or more other criteria of interest. This could include, for example, only detecting interactions with particularly selected shared virtual components (as may be so designated by a shared experience administrator, one or more of the participants, or the like), only detecting interactions of a particular category, kind, or degree, and/or only detecting interactions as involve particularly identified participants. Those skilled in the art will recognize that other possibilities exist as well. Generally speaking, for many application settings, this interaction can comprise a real-world movement by the second participant and/or manipulation of a virtual reality user interface by that second participant.

Upon detecting 105 such an interaction, this process 100 can then provide for causing the aforementioned step of rendering 103 for the first participant to be modified such that this process 100 now renders 106 for the first participant a virtual representation of the second participant's interaction with the shared experience as though the interaction between the second participant and the shared virtual component had not occurred (at least in part). Such can occur notwithstanding that this process 100 still continues to provide for rendering, for the second participant, a virtual representation of their interaction with the shared virtual component. Simply put, by one simple illustrative example, the participant doing the interacting receives a rendering that comports with those interactions while another participant receives a rendering that persists with a presentation of that experience as though such an interaction were not occurring (or had occurred).

So configured, a sharable virtual object can be observed and manipulated as desired by one or more participants of a virtual reality experience without precluding one another from such behaviors by their own activity in this regard. If desired, these teachings can be facilitated in a manner that permits, for example, all five participants of a shared experience to each essentially simultaneously manipulate and study a given shared virtual component to satisfy the requirements of their purposes and needs without interfering with one another.

By one approach, this step of detecting and responding as described can comprise an automatic activity that is triggered in response to such inputs as are available in a given application setting. By another approach, these actions can assume a more deliberate guise where a given participant might themselves select to impose such processing while they temporarily examine a shared virtual component that is otherwise undergoing group inspection and consideration. In either case, if desired, a time frame during which such treatment prevails can be left unbounded or can be automatically terminated upon the expiration of some predetermined time, count, or other trigger of choice. By the latter approach, for example, a given participant could manipulate and view a given shared virtual component in a manner as described for, say one minute. At the expiration of that time frame, however, that participant's manipulation of the shared virtual component might then be automatically shared with one or more of the remaining participants via corresponding rendering of the shared environment that now takes into account those manipulations.

There are various ways by which this activity of rendering for the first participant a virtual representation of the second participant's interaction with the shared experience as though the aforementioned detected interaction had not occurred can be undertaken. By one approach, for example, this can comprise rendering the shared virtual component as though the second participant had not interacted with the shared virtual component. As one simple illustrative example, when the second participant has moved the shared virtual component closer to themselves in order to facilitate a visual inspection thereof, this can comprise rendering the shared virtual component for the first participant as though the shared virtual component had not, in fact, been moved. This can also comprise, in combination with or in lieu of the foregoing, rendering depictions of the second participant as though the interaction between the second participant and the shared virtual component had not occurred.

In some cases, it is possible for some treatment in this regard to lead to certain ambiguities or points of confusion as the experience progresses. As one illustration, if the second participant moves the shared virtual component to a new position while studying that component, it may be confusing to the first participant to see the shared virtual component in its original, unmoved position while also seeing the second participant's avatar seemingly gazing in a direction other than towards the shared virtual component (which direction may accord, of course, to the actual present position of the shared virtual component as being rendered for the benefit of the second participant).

If desired, then, these teachings will also accommodate rendering one or more subsequent interactions between the second participant and the shared virtual component as though the first interaction between the second participant and the shared virtual component had not occurred. By way of an illustrative example, when the first interaction comprises, at least in part, moving that shared virtual component and the second interaction comprises, at least in part, directing the second participant's attention towards the shared virtual component, this can comprise rendering the depiction to depict the second participant as directing their attention (for example, by gazing) towards where the shared virtual component would have been had the second participant not moved the shared virtual component as per the first interaction.

So configured, at least a certain degree of consistency will be retained with respect to at least some relative interactions between such a participant and such a shared virtual component. The first participant, in such an example, will be able to (correctly) ascertain that the second participant is looking at the shared virtual component notwithstanding that the shared virtual component no longer shares a common location in the shared experience for both participants. This can comprise a powerful, albeit subtle, informational and contextual cue to inform and influence the course of the participant's use and interpretation of the virtual reality experience.

As alluded to above, the actions described above can be automatically applied in a comprehensive manner or, if desired, can be applied in a more selective manner. For example, these teachings will accommodate the use of at least a first and a second rendering condition and the corresponding receipt 107 of information regarding the use or non-use of such conditions in a given and/or a general sense. So configured, for example, the process of rendering the second participant's interaction with the shared experience for the first participant as though the interaction had not occurred can be effected when the first rendering condition is applicable 108. When the second rendering condition is applicable 109, however, this process 100 can then provide instead for rendering for the first participant a virtual representation of the second participant's interaction with the shared virtual component such that the first participant instead is able to perceive the second participant's actual interaction with that component.

This approach will therefore be seen to provide a mechanism for selecting between these two (or more) rendering options. The rendering conditions themselves can be established via any mechanism of choice. By one approach the condition can comprise a relatively static condition that may only change on occasion as per the wishes of a system administrator. By another approach the condition can comprise a relatively dynamic option that may change any number of times during a single virtual reality experience in response to any number of stimuli and/or points of control or influence.

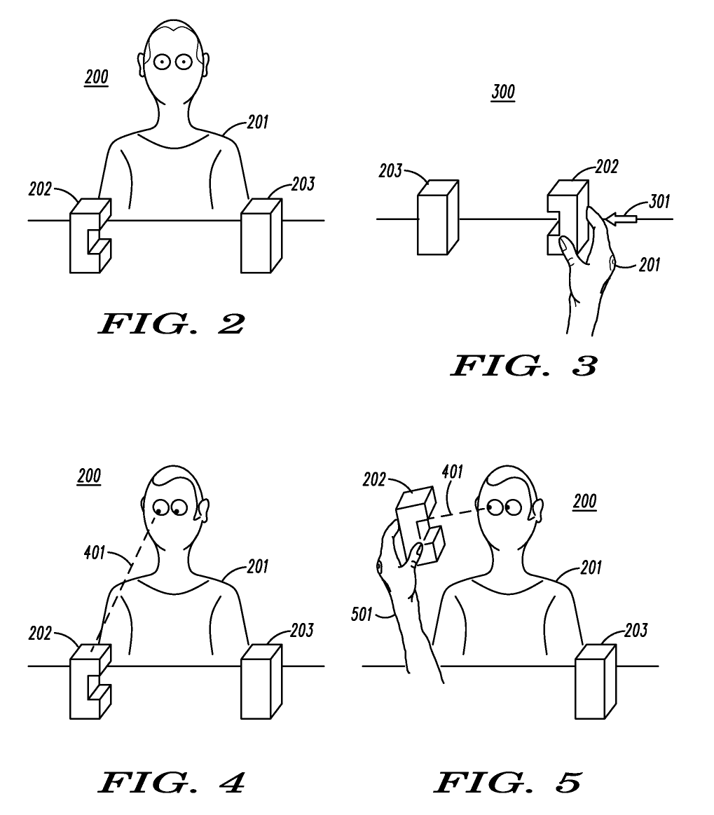

Referring now to FIGS. 2 through 5, a more specific illustrative example will be provided. Those skilled in the art will appreciate and recognize that the use of such an example is intended to serve only as an illustrative example and is not intended to serve as an exhaustive or otherwise limiting example in this regard.

In this example, and referring more specifically to FIG. 2, a virtual reality experience as rendered for a first participant provides a view 200 (from a point of view as corresponds to the first participant) of a shared experience that includes a second participant 201 as well as a first and a second shared virtual component 202 and 203. FIG. 3 provides a view 300 (from a point of view as corresponds to the second participant 201) that includes the first and second shared virtual components 202 and 203. For the sake of simplicity and clarity, the first participant is not shown in FIG. 3 but would, in a typical application setting, likely be visible in such a view 300. In FIG. 3, it can be seen that the second participant 201 is moving the first shared virtual component 202 from its initial position as shown in FIG. 2 to a new position that is more central to the second participant's field of view (as suggested by the arrow denoted by reference numeral 301).

In this example, this movement of the first shared virtual component 202 by the second participant 201 comprises a detected interaction as described above. Accordingly, although the second participant's view 300 reflects this interaction as shown in FIG. 3, the first participant's view 200 as shown in FIG. 4 renders the shared experience as though such an interaction had not occurred. Instead, as shown, the first shared virtual component remains in its initial position.

In this example, however, the second participant's subsequent interactions with the shared virtual components (to the extent that such interactions relate to a direction of gaze) remain accounted for and are taken into account. Accordingly, as the second participant is gazing at this first shared virtual component (albeit in its new position in the second participant's view 300), the second participant's gaze 401 is directed, in the first participant's view 200, towards the first shared virtual component. So configured, the direction of the second participant's gaze 401 is incorrect in a Cartesian sense but is nevertheless substantively correct; this direction of gaze correctly informs the first participant of that which the second participant is presently looking at.

Accordingly, and referring now to FIG. 5, if the first participant 501 were now to move the first shared virtual component 202 to a new location, the first participant's view 200 will correctly reflect this movement (even while the second participant's view 300 may not) and will further continue to depict that that second participant's gaze 401 continues to remain directed towards that first shared virtual component.

There are various ways by which such teachings can be implemented in a given application setting. By one approach we can use non-orthogonal multi-basis vector mappings to maintain consistency among multiple participants described as follows.

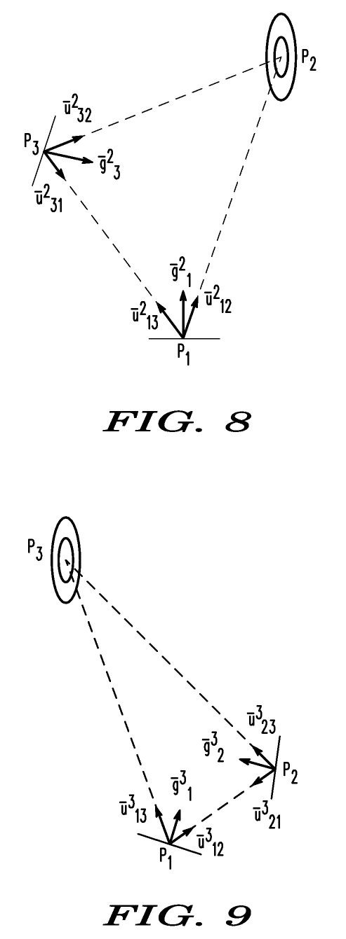

Consider, for example, a 2-dimensional case in which 3 participants {P₁, P₂, and P₃} are initially placed equidistant from each other, around a circular table, in a default setting. Each participant is then allowed to re-configure this default setting by optionally moving either or both of the other two participants (and/or other shared objects of interests) in his local view as illustrated graphically in FIGS. 7, 8, and 9 for concurrent states of the corresponding experiences. In this exemplary 2-dimensional case, the participants' heads can only turn to the left or to the right directions, and can move in the plane parallel to the table top. The problem to be solved is then how to maintain consistent rendering of the shared objects to all participants in this virtual communication system. As a practical result, when any participant is looking at, moving towards, or somehow manipulating an object at his or her local view, this should be reflected consistently in all local views, regardless of the configuration settings performed by each participant to their local view in a customization mode.

Formally, we first define the following variable parameters to describe the mappings required for facilitating the desired consistencies:

Configuration Vectors u^{k}ᵢⱼ
Each participant Pₖ (also referred to herein as “point”) defines unit vectors u^{k}ᵢⱼ pointing from point Pᵢ to point Pⱼ according to his local configuration (preferences), such that: |u^{k}ᵢⱼ|=1, u^{k}ᵢⱼ=−u^{k}ⱼᵢ.
   Attraction Matrix {aᵢⱼ}
Element aᵢⱼ measures to what degree participant (point) Pᵢ is oriented (attracted) towards participant (point) Pⱼ in their local space.
   Orientation Vectors g^{k}ᵢ

Participant Pₖ constructs their orientation vector g^{k}ₖ, sends it to the others, and computes the other's orientation vectors g^{k}ᵢ using received orientation vectors and stored configuration vectors.

Movement Matrix {mᵢⱼ}
Element mᵢⱼ measures to what degree the participant (point) Pᵢ is moved towards participant (point) Pⱼ in their local space.
   Displacement Vectors d^{k}ᵢ
Participant Pₖ constructs their displacement vector d^{k}ₖ, sends it to the others, and computes the other's displacement vectors d^{k}ᵢ using received displacement vectors and stored configuration vectors.

The orientation vectors shown in FIGS. 7, 8, and 9 can then be expressed as:

\vec{g}₁¹ is constructed and sent to others

\vec{g}₂¹=a₂₁\vec{u}₁₂¹+a₂₃\vec{e}₂₃¹

\vec{g}₃¹=a₃₁\vec{u}₃₁¹+a₃₂\vec{u}₃₂¹ (1)

\vec{g}₁²=a₁₂\vec{u}₁₂²+a₁₃\vec{u}₁₃²

\vec{g}₂² is constructed and sent to others

\vec{g}₃²=a₃₁+\vec{u}₃₁²+a₃₂\vec{u}₃₂² (2)

\vec{g}₁³=a₁₂\vec{u}₁₂³+a₁₃\vec{u}₁₃³

\vec{g}₂³=a₂₁\vec{u}₂₁³+a₂₃\vec{u}₂₃³

\vec{g}₃³ is constructed and sent to others (3)

respectively. As will be well understood by those skilled in the art, the construction process can be implemented using motion capture devices such as electronic head trackers, or other input devices, for controlling the display.

Generally, for orientation vectors we have,

$${\vec{g}}_{s}^{k} = {\sum }_{j = 1}^{{n}_{k}} {a}_{sj} {\vec{u}}_{sj}^{k} , s \neq k \qquad ( 4 )$$

where (nₖ≧3) is the number of objects of interest to participant Pₖ.

Similarly, for displacement vectors, replacing (a by m) and (g by d) in equation (4), then we have the following recasting for the displacement formula:

$${\vec{d}}_{s}^{k} = {\sum }_{j = 1}^{{n}_{k}} {m}_{sj} {\vec{u}}_{sj}^{k} , s \neq k \qquad ( 5 )$$

Now, without loss of generality regarding the dimensionality of the space for each local view, assume that a participant chose n points of interest, representing some or all of the shared objects in the virtual reality space, and configured them such that their configuration parameters were characterized by the set, U, of unit length (but not necessarily orthogonal) configuration vectors:

U={\vec{u}₁,\vec{u}₂, . . . ,\vec{u}ₙ} (6)

Any vector, v, in this space (representing orientation, displacement, or any possible alteration of the state of a selected object) can be expressed as a linear combination of the configuration vectors by:

\vec{v}=c₁\vec{u}₁+c₂\vec{u}₂+ . . . +cₙ\vec{u}ₙ (7)

If we take the vector Dot Product operation, “.”, of equation (7) by each configuration vector in equation (6), we have the following matrix equation:

$$[ \begin{matrix}\vec{v} . {\vec{u}}_{1} \\ \vec{v} . {\vec{u}}_{2} \\ ⋮ \\ ⋮ \\ ⋮ \\ \vec{v} . {\vec{u}}_{n}\end{matrix} ] = [ \begin{matrix}{\vec{u}}_{1} . {\vec{u}}_{1} & {\vec{u}}_{2} . {\vec{u}}_{1} & ⋯ & {\vec{u}}_{n} . {\vec{u}}_{1} \\ {\vec{u}}_{1} . {\vec{u}}_{2} & {\vec{u}}_{2} . {\vec{u}}_{2} & ⋯ & {\vec{u}}_{n} . {\vec{u}}_{2} \\ ⋮ & ⋮ & ⋯ & ⋮ \\ ⋮ & ⋮ & ⋯ & ⋮ \\ ⋮ & ⋮ & ⋯ & ⋮ \\ {\vec{u}}_{1} . {\vec{u}}_{n} & {\vec{u}}_{2} . {\vec{u}}_{n} & ⋯ & {\vec{u}}_{n} . {\vec{u}}_{n}\end{matrix} ] [ \begin{matrix}{c}_{1} \\ {c}_{2} \\ ⋮ \\ ⋮ \\ ⋮ \\ {c}_{n}\end{matrix} ] \qquad ( 8 )$$

Now denoting,

wᵢⱼ=\vec{u}ᵢ.\vec{u}ⱼ (9)

bᵢ=\vec{v}.\vec{u}ᵢ (10)

we have the matrix equation for computing the vector b={bᵢ} as:

$$[ \begin{matrix}{b}_{1} \\ {b}_{2} \\ ⋮ \\ ⋮ \\ ⋮ \\ {b}_{n}\end{matrix} ] = [ \begin{matrix}{w}_{11} & {w}_{21} & ⋯ & {w}_{n 1} \\ {w}_{12} & {w}_{21} & ⋯ & {w}_{n 2} \\ ⋮ & ⋮ & ⋯ & ⋮ \\ ⋮ & ⋮ & ⋯ & ⋮ \\ ⋮ & ⋮ & ⋯ & ⋮ \\ {w}_{1 n} & {w}_{2 n} & ⋯ & {w}_{nn}\end{matrix} ] [ \begin{matrix}{c}_{1} \\ {c}_{2} \\ ⋮ \\ ⋮ \\ ⋮ \\ {c}_{n}\end{matrix} ] \qquad ( 11 )$$

If we choose, or enforce, the unit vectors to be non-coplanar, then the symmetric configuration matrix W={wᵢⱼ} will be positive definite and we can solve for the unknown coefficient vector c={cᵢ} simply by computing:

\vec{c}=W⁻¹\vec{b} (12)

By definition, we already have

\vec{u}ᵢ.\vec{u}ᵢ=1, ∀i ε {1, . . . ,n} (13)

wᵢⱼ=\vec{u}ᵢ.\vec{u}ⱼ=\vec{u}ⱼ.\vec{u}ᵢwⱼᵢ, ∀i, j ε {1, . . . ,n} (14)

To facilitate invertibility of the configuration matrix W={wᵢⱼ}, each participant can have (by choice or system control) configuration parameters such that:

(\vec{u}ᵢ.\vec{u}ⱼ)²≠1, ∀i≠j (15)

and

(\vec{u}ᵢ×\vec{u}ⱼ).\vec{u}ₕ≠0, ∀i≠j≠h (16)

where “X” is the standard vector Cross Product operation, for general 3-dimensional virtual reality experience cases. If it happen that a configuration matrix, W, to any participant interfacing in the communication session is not invertible for any reason, if desired the system controller can adjust the configuration vectors or simply prompt the participant to do so until a suitable mapping, W⁻¹, is obtained. Additional constraints may also be imposed to suit different applications or even certain views within the same application.

By one approach the matrix inversion computation process for obtaining W⁻¹ is performed and optionally stored only during the configuration mode of each participant interface, separately. This may be preferable in many application settings because these matrix elements may be determined only by their corresponding configuration vectors for each participant. In some use cases, one may allow some participants to re-configure certain objects during the operation mode as well, i.e. continuously on the fly. This type of usage will require dynamic re-computation of the corresponding W⁻¹, and there is no need to store it unless such re-configuration is desired to remain static at least during some time intervals of the communication session.

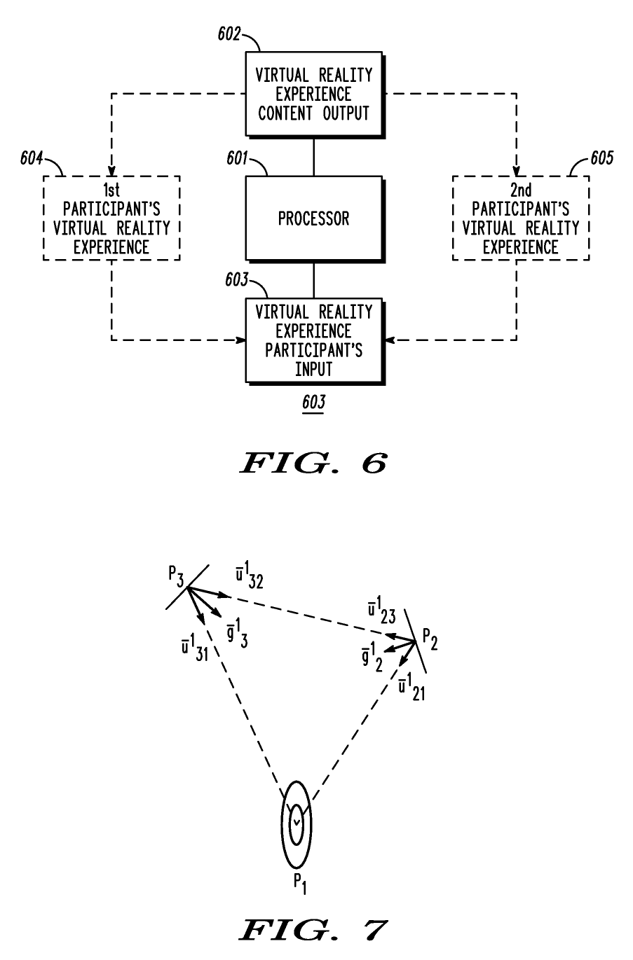

Those skilled in the art will appreciate that the above-described processes are readily enabled using any of a wide variety of available and/or readily configured platforms, including partially or wholly programmable platforms as are known in the art or dedicated purpose platforms as may be desired for some applications. Referring now to FIG. 6, an illustrative approach to such a platform will now be provided.

In this illustrative embodiment, the enabling apparatus 600 generally comprises a processor 601 that operably couples to a virtual reality experience content output 602 and a virtual reality experience participant's input 603. The virtual reality experience content output 602 can operably couple to a rendering platform of choice for a first and a second participant's virtual reality experience 604 and 605. Similarly, the virtual reality experience participant's input 603 can operably couple to receive participant's input from those same two virtual reality experiences 604 and 605. Those skilled in the art will recognize that only two such experiences are shown for the sake of simplicity and clarity and that any number of participants can be so accommodated. It will also be appreciated that these experiences can couple as described through essentially any communications medium including but not limited to both wired and wireless pathways as well as any of a variety of public and private networks. Such system components as well as these architectural options are well known in the art. As the present teachings are not overly sensitive to the selection of any particular approach in these regards, for the sake of brevity and the preservation of clarity additional elaboration in this regard will not be provided here.

So configured, by one approach, the processor 601 can be configured and arranged (via, for example, appropriate and corresponding programming) to perform some or all of the previously described steps and actions. Those skilled in the art will recognize and understand that such an apparatus 600 may be comprised of a plurality of physically distinct elements as is suggested by the illustration shown in FIG. 6. It is also possible, however, to view this illustration as comprising a logical view, in which case one or more of these elements can be enabled and realized via a shared platform. It will also be understood that such a shared platform may comprise a wholly or at least partially programmable platform as are known in the art.

Those skilled in the art will recognize that a wide variety of modifications, alterations, and combinations can be made with respect to the above described embodiments without departing from the spirit and scope of the invention, and that such modifications, alterations, and combinations are to be viewed as being within the ambit of the inventive concept. As one example in this regard, when rendering the shared experience for a given participant as though an interaction between that shared experience and another of the participants had not occurred, one can nevertheless provide other information to the given participant to alert them to the fact that such interaction has (or is), in fact, occurring. By one approach, for example, this might comprise rendering the avatar of the other participant with a property (such as a color, aura, or the like) which is indicative of such a circumstance.

We claim:

1. A method comprising:
substantially continuously providing a first virtual reality experience for a first participant;
substantially continuously providing a second virtual reality experience for a second participant, wherein the first virtual reality experience and the second virtual reality experience comprise a shared experience that comprises, at least in part, a shared virtual component;
substantially continuously rendering for the first participant a virtual representation of the second participant's interaction with the shared experience which rendering comprises, at least in part, rendering a virtual presentation of the shared virtual component from a point of perception as corresponds to the first participant;
substantially continuously rendering for the second participant a virtual representation of the second participant's interaction with the shared experience which rendering comprises, at least in part, rendering a virtual presentation of the shared virtual component from a point of perception as corresponds to the second participant;
detecting an interaction between the second participant and the shared virtual component wherein upon detecting the interaction:
substantially continuously rendering for the first participant a virtual representation of the second participant's interaction with the shared experience comprises, at least in part, rendering for the first participant a virtual representation of the second participant's interaction with the shared experience as though the interaction between the second participant and the shared virtual component had not occurred; and
substantially continuously rendering for the second participant a virtual representation of the second participant's interaction with the shared experience comprises, at least in part, rendering for the second participant a virtual representation of the second participant's interaction with the shared virtual component.

2. The method of claim 1 wherein the shared experience comprises a substantially real time, live public safety management experience.

3. The method of claim 1 where in the shared virtual component comprises a participant-manipulable object.

4. The method of claim 1 wherein detecting an interaction between the second participant and the shared virtual component comprises, at least in part, at least one of:
detecting movement by the second participant;
detecting manipulation of a virtual reality user interface by the second participant.

5. The method of claim 1 wherein rendering for the first participant a virtual representation of the second participant's interaction with the shared experience as though the interaction between the second participant and the shared virtual component had not occurred comprises, at least in part:
rendering the shared virtual component as though the second participant had not interacted with the shared virtual component.

6. The method of claim 5 wherein rendering for the first participant a virtual representation of the second participant's interaction with the shared experience as though the interaction between the second participant and the shared virtual component had not occurred further comprises, at least in part:
rendering depictions of the second participant as though the interaction between the second participant and the shared virtual component had not occurred.

7. The method of claim 6 wherein rendering depictions of the second participant as though the interaction between the second participant and the shared virtual component had not occurred comprises, at least in part, rendering a subsequent interaction between the second participant and the shared virtual component as though the interaction between the second participant and the shared virtual component had not occurred.

8. The method of claim 7 wherein:
the interaction comprises, at least in part, moving the shared virtual component; and
the subsequent interaction comprises, at least in part, directing the second participant's attention towards the shared virtual component;
such that rendering the depiction comprises, at least in part, depicting the second participant as directing their attention towards where the shared virtual component would have been had the second participant not moved the shared virtual component.

9. The method of claim 8 wherein directing the second participant's attention towards the shared virtual component comprises, at least in part, the second participant gazing at the shared virtual component.

10. The method of claim 1 wherein the point of perception comprises a point of view.

11. The method of claim 1 wherein rendering for the first participant a virtual representation of the second participant's interaction with the shared experience as though the interaction between the second participant and the shared virtual component had not occurred comprises, at least in part, automatically rendering for the first participant a virtual representation of the second participant's interaction with the shared experience as though the interaction between the second participant and the shared virtual component had not occurred when a first rendering condition as corresponds to the shared virtual component is applicable.

12. The method of claim 11 further comprising, upon detecting the interaction:
rendering for the first participant a virtual representation of the second participant's interaction with the shared virtual component when a second rendering condition as corresponds to the shared virtual component is applicable.

13. The method of claim 12 further comprising:
receiving information regarding at least one of the first and second rendering condition.

14. An apparatus comprising:
a virtual reality experience content output;
a virtual reality experience participant's input;
a processor operably coupled to the virtual reality experience content output and the virtual reality experience participant's input and being configured and arranged to:
substantially continuously provide a first virtual reality experience via the virtual reality experience content output for a first participant;
substantially continuously provide a second virtual reality experience via the virtual reality experience content output for a second participant, wherein the first virtual reality experience and the second virtual reality experience comprise a shared experience that comprises, at least in part, a shared virtual component;
substantially continuously render for the first participant a virtual representation of the second participant's interaction with the shared experience by, at least in part, rendering a virtual presentation of the shared virtual component from a point of perception as corresponds to the first participant;
substantially continuously render for the second participant a virtual representation of the second participant's interaction with the shared experience by, at least in part, rendering a virtual presentation of the shared virtual component from a point of perception as corresponds to the second participant;
detect an interaction between the second participant and the shared virtual component via the virtual reality experience participant's input and responsively:
substantially continuously render for the first participant a virtual representation of the second participant's interaction with the shared experience by, at least in part, rendering for the first participant a virtual representation of the second participant's interaction with the shared experience as though the interaction between the second participant and the shared virtual component had not occurred; and
substantially continuously render for the second participant a virtual representation of the second participant's interaction with the shared experience by, at least in part, rendering for the second participant a virtual representation of the second participant's interaction with the shared virtual component.

15. The apparatus of claim 14 wherein the processor is further configured and arranged to render for the first participant a virtual representation of the second participant's interaction with the shared experience as though the interaction between the second participant and the shared virtual component had not occurred by, at least in part:
rendering the shared virtual component as though the second participant had not interacted with the shared virtual component.

16. The apparatus of claim 15 wherein the processor is further configured and arranged to render for the first participant a virtual representation of the second participant's interaction with the shared experience as though the interaction between the second participant and the shared virtual component had not occurred by, at least in part:
rendering depictions of the second participant as though the interaction between the second participant and the shared virtual component had not occurred.

17. The apparatus of claim 16 wherein the processor is further configured and arranged to render depictions of the second participant as though the interaction between the second participant and the shared virtual component had not occurred by, at least in part, rendering a subsequent interaction between the second participant and the shared virtual component as though the interaction between the second participant and the shared virtual component had not occurred.

18. The apparatus of claim 17 wherein:
the interaction comprises, at least in part, moving the shared virtual component; and
the subsequent interaction comprises, at least in part, directing the second participant's attention towards the shared virtual component;
and wherein the processor is further configured and arranged to render the depiction by, at least in part, depicting the second participant as directing their attention towards where the shared virtual component would have been had the second participant not moved the shared virtual component.

19. The apparatus of claim 14 wherein the processor is further configured and arranged to render for the first participant a virtual representation of the second participant's interaction with the shared experience as though the interaction between the second participant and the shared virtual component had not occurred by, at least in part, automatically rendering for the first participant a virtual representation of the second participant's interaction with the shared experience as though the interaction between the second participant and the shared virtual component had not occurred when a first rendering condition as corresponds to the shared virtual component is applicable.

20. The apparatus of claim 19 wherein the processor is further configured and arranged, upon detecting the interaction, to render for the first participant a virtual representation of the second participant's interaction with the shared virtual component when a second rendering condition as corresponds to the shared virtual component is applicable.
